(19) United States
(12) Patent Application Publication
(10) Pub. No.: US 2022/0343419 A1
(43) Pub. Date: Oct. 27, 2022

(54) METHOD AND PRODUCT FOR TRACKING CURRENCY TRANSFER

(71) Applicant: RollsPack Pty Ltd, Braeside (VIC) (AU)

(72) Inventors: Phillip Rolls, Black Rock (VIC) (AU); Craig Ashby, Hamilton (NZ)

(21) Appl. No.: 17/765,854

(22) PCT Filed: Oct. 1, 2020
(86) PCT No.: PCT/AU2020/051047

§ 371 Date: Apr. 1, 2022

(30) Foreign Application Priority Data
Oct. 2, 2019 (AU) 2019903705

(51) Int. Cl. G06Q 40/02; G06Q 10/08

(52) U.S. Cl. CPC G06Q 40/02; G06Q 10/0833; G06K 19/06028

(57) ABSTRACT

Described herein is a method, product and system for tracking currency transfer, said method comprising use of a currency security bag containing currency and a series of steps to securely monitor information corresponding to the security bag. The security bag allows for a user to track the currency from a point of deposit until reaching a destination.

### FIELD OF THE INVENTION

The present invention relates to a method and product for currency transfer, more particularly a method for currency transfer using a currency security bag and means for depositing, viewing and tracking information relating to the currency security bag.

### BACKGROUND OF THE INVENTION

Processes for depositing, monitoring and tracking of cash flow between customers and financial institutions require many layers of human interaction such as cash counting, recording depositor information and recording cash flow. Further, these layers also result in double handling of currency leaving these systems susceptible to breakdown through human error. Such processes are also typically inefficient, resulting in increased operating costs relating to monitoring and additional staffing to ensure accuracy and efficiency.

Security also presents a major concern when monitoring and tracking cash flow. Not only are there concerns with the security of the goods/currency being transferred, but also the information belonging to the depositor, such as personal information and banking details.

Again, typical methods for tracking and monitoring cash flow require layers of human interaction to ensure this security is enforced which ultimately results in increased costs the intuition responsible for maintaining the security.

Current process for transferring and depositing currency into financial institutions (e.g. banks) requires placing the currency into a plastic bag designed for carrying currency, physically taking the currency into a bank branch, placing the bag into a deposit box within the bank branch and opening the bag within the bank branch for the currency to be counted and verified. Alternatively, pre prepared currency bags may be attached with a label (e.g. a deposit slip/deposit paper voucher) and collected and transferred by a courier for delivery to a bank or other 3^{rd} party for processing.

There exists a need to overcome, or at least alleviate, one or more of the difficulties or deficiencies associated with the prior art, or to provide an alternative to the existing system.

### SUMMARY OF THE INVENTION

In one aspect the present invention provides a method for tracking currency transfer, comprising the steps of:
providing a security bag for holding currency;
depositing currency into the security bag;
entering information identifying the security bag into a database; and
updating the database with at least one location of the security bag;
wherein the security bag may be tracked by a user from a point of deposit until reaching a destination by remote accessing of the database.

In a second aspect of the present invention there is provided a currency security bag comprising:
a machine readable code; and
a wireless identifier;

which enable said currency security bag to be identified so that it can be tracked from a point of deposit until reaching a destination.

In a third aspect of the present invention there is provided a tracking system for tracking currency transfer in a security bag having a machine readable code and a wireless identifier, said system comprising:
a first reader, a server and a second reader;
wherein the first reader is operatively arranged to read the machine readable code at a commencement location, the reader operatively arranged to read the machine readable code and extract information and an identifier of the security bag from the code, the information operative to trigger a connection to a remote server;
wherein the remote server is arranged to receive the identifier and information about the currency to be transported and recording the identifier and the currency information;
wherein the second reader is operatively arranged to receive an identifier of the security bag from the wireless identifier at a destination location;
wherein the remote server is configured upon receipt of the identifier by the second reader to receive from a destination device said identifier, wherein the server is configured to retrieve the information about the currency based on the identifier provided to the server and one or both of: provide the information about the currency to the destination device; and record the time of the second reader receiving the identifier of the security bag.

By currency as used herein is meant any form of money, asset, property or resource of commercial value.

In an embodiment the machine readable code comprises a barcode. In an embodiment the machine readable code comprises a first barcode and/or a second barcode. In an embodiment the wireless identifier comprises an RFID tag.

In an embodiment the currency to be tracked may include cash, bank notes, coins, bank cheques/checks, bills, receipts any form of local or foreign money, or valuables of any type.

By barcode as used herein is meant any visual form of machine readable data. This may exclude optical character read (OCR) codes.

In an embodiment the first barcode may include a one-dimensional (1D) barcode, a two dimensional (2D) barcode, a three dimensional (3D) barcode, or any suitable combination thereof. In a preferred embodiment the first barcode is a primary barcode and is a 1D barcode.

In an embodiment the second barcode may include a one-dimensional (1D) barcode, a two dimensional (2D) bar code, a three dimensional (3D) barcode, or any suitable combination thereof. In a preferred embodiment the second barcode is a secondary barcode and is a two dimensional (2D) barcode. In a further preferred embodiment the secondary barcode is a quick response (QR) code.

In an embodiment the RFID tag may include any active, passive or semi-passive RFID tag. In a preferred embodiment the RFID tag may include any long range passive ultra-high frequency RFID tag.

In an embodiment the primary barcode provides a first means for assignment of a unique ID tag to the security bag. The unique ID tag can be recorded in the database as a key identifier of the security bag.

In an embodiment the secondary barcode provides access to the database. In a preferred embodiment the secondary barcode provides access to a database by the secondary barcode being correlated with the primary barcode in the database, allowing for assignment of a unique ID tag to the security bag.

In an embodiment the secondary barcode provides accesses to a URL to allow for entry and recording of deposit data indicative of the contents of the security bag into the database.

In an embodiment, upon confirmation of the deposit data being recorded in the database, reuse of the secondary code as a deposit URL is deactivated.

In an embodiment, upon confirmation of the deposit data being recorded in the database, a user is sent a confirmation notification.

In a further embodiment upon confirmation of the deposit data being received, the deposit data is encrypted and recorded in the deposit database.

By deposit URL as used herein is meant a link encoded in the secondary code to provide a means for access to a remote interface, which identifies the security bag from the secondary code and facilitates entry of the deposit data. In an embodiment the secondary code comprises a unique link with the identification of the security bag embedded in the unique link.

By encryption as used herein is meant any standard encryption method, such as is provided by a Cloud Native Server, and with encryption features as required by the user.

The database may be implemented on a remote server, such as a cloud server. The database comprises deposit information and preferably the server implements security features such as provided by a cloud hosting company (e.g. Amazon Web Services™).

Deposit data as used herein may include value of currency, denominations, units of currency, account name for deposit, account number for deposit, name of depositor, date or deposit, time of deposit.

In an embodiment the security bag is assigned to a depositor and the identity of the depositor is recorded in the database in association with the identifier of the security bag.

In an embodiment the deposit data includes auto-populated data corresponding to the information recorded as assigned to the unique ID tag.

Auto-populated data as used herein may include customer details or any other details as required by the customer.

By a unique ID tag as used herein is meant a unique identifier. The unique ID tag allows a user access to a deposit URL to record the deposit data. In a preferred embodiment the unique ID tag is a number that links together the primary barcode, the secondary bar code and the RFID tag, such as by being a relational database key.

In an embodiment the RFID tag provides access to the database. In a preferred embodiment the RFID tag provides access to the database by providing access information identifying the security bag. In an embodiment the access information directs the server to retrieve information from the database to allow for viewing:
data corresponding to the unique ID tag and/or
data corresponding to the deposit data.

In a further embodiment the RFID tag further provides access to the database to provide a means for entry of status data.

By status data as used herein may include tag location, time and date stamp of recorded GPS location of the scanning of the machine readable code and/or a RFID tag, a user identifier, such as a RFID Chip attached to an individual.

In an embodiment the step of depositing currency into the security bag comprises:
placing currency to be transferred inside the bag, and/or
scanning a secondary code to receive a unique deposit code corresponding to the bag.

By unique deposit code as used herein is meant an identifier code, number code, alphanumeric code or any other suitable identifier which is attached to the primary barcode, the secondary barcode and the number associated with the RFID tag.

In an embodiment the information associated with the security bag comprises:
personal details of the user, and/or
details of currency to be deposited.

In an embodiment upon depositing the bag a user receives a notification confirming the deposit. In an embodiment the notification comprises details of the deposit, such as time of the deposit. In a further preferred embodiment, the notification includes a code corresponding to the location of the security bag where the deposit is made.

As used herein the notification may be in the form of an email or SMS response to the user.

In an embodiment the database provides notification when a security bag has already been used.

In an embodiment the database provides means for generating a report. In a preferred embodiment the report is in the form of a CSV file or similar format. Multiple reports or report formats are possible

In a fourth aspect of the present invention there is provided a computer program embodied in a physical form comprising instructions for controlling a computer to:
receive from a first reader at a first remote location an identifier of a security bag read from a code on the security bag by the first reader;
provide to a user of the first reader a link that enables a connection to the server;
receive from the user information about currency to be transported in the security bag;
record the identifier and the currency information;
receive from a second reader at a second location an identifier of the security bag read from a wireless identifier on the security bag by the second reader;
retrieving the currency information based on the identifier of the security bag read from a wireless identifier;
sending to a destination device at the second location the retrieved currency information.

In an embodiment the instructions are also configured to control the computer to:
record the time of the second reader receiving the identifier of the security bag; and
provide the recorded time to the user.

In a fifth aspect of the present invention there is a system comprising means for implementing fourth aspect.

In a sixth aspect of the present invention there is a method performed by a system when executing the computer program of the fourth aspect.

In this specification, the term ‘comprises’ and its variants are not intended to exclude the presence of other integers, components or steps.

In this specification, reference to any prior art in the specification is not and should not be taken as an acknowledgement or any form of suggestion that this prior art forms part of the common general knowledge in Australia or any other jurisdiction or that this prior art could reasonably expected to be combined by a person skilled in the art.

The present invention will now be more fully described with reference to the accompanying Examples and drawings. It should be understood, however, that the description following is illustrative only and should not be taken in any way as a restriction on the generality of the invention described above.

### BRIEF DESCRIPTION OF THE DRAWINGS/FIGURES

In the Figures:

FIG. 1 illustrates a user work flow according to an embodiment of the present invention.

FIG. 2 shows example features of an embodiment of a security bag according to an embodiment of the present invention.

FIG. 3 shows a flow process according to an embodiment of the present invention.

FIG. 4 is a schematic diagram of a security bag according to an embodiment of the present invention.

FIG. 5 is a schematic block diagram of a system for tracking a security bag according to an embodiment of the present invention.

### DETAILED DESCRIPTION OF THE EMBODIMENTS

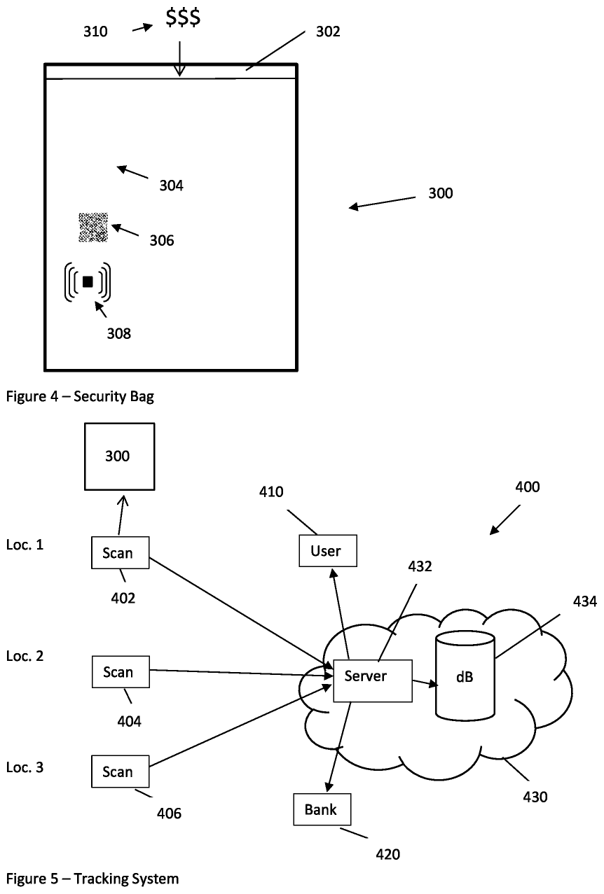

Referring to FIG. 4, there is a schematic representation of a security bag 300 according to an aspect of the present invention, which comprises an opening 302 for receiving a currency 310, such as monetary bills/notes. In an embodiment the bag comprises a 1 dimensional barcode 304, which is an encoded identification readable by a scanner, a 2 dimensional barcode or matrix barcode, such as a Quick Reference (QR) code 306, which encodes information, such as an identifier and a URL, and a wireless identifier, such as a RFID 308, which is an encoded a radio frequency transmission of an identifier and optionally other information. The barcode 304, QR code 306 and RFID 308 enable the security bag 300 to be identified so that it can be tracked from a point of deposit (such as Location 1 in FIG. 5) until reaching a destination (such as Location 2 in FIG. 5).

Referring to FIG. 5, there is a system 400 according to an aspect of the present invention, which comprises at least one scanner, in this case 3 scanners 402, 404, and 406, which are arranged to be able to communicate with a cloud server 430, which comprises a server device or a virtual server 432 and a database 434. The cloud server 430 is able to be accessed by a user device 410 and preferably another device, such as a bank system, 420.

The server 430 is configured with a processor (such as a virtual CPU), memory (such as an allocation of virtual memory, a data storage device (such as a virtual disk drive) and a computer network connection (such as a connection to the Internet). The server 430 also comprises application software comprising instructions stored in the data storage which are created to control the processor and other elements of the server 430 to operate as described herein. The description herein will serve as a blueprint for a computer programmer (or team) to implement in an operative form the application software as defined in this specification by use of standard computer programming techniques.

The system 400 enables implementation of a method for tracking currency transfer, comprising the steps of:
providing the security bag 300 for holding currency to enable a user wishing to transfer currency from one location to another;
depositing currency 310 into the security bag 300 via the opening 302;
scanning one or more of the identifiers 304, 306 or 308 at a first location (Loc 1) to enable entering information identifying the security bag 300 into the database 434; and
when the bag 300 has been transported to the desired location (Loc 2) scanning one or more of the identifiers 304, 306 or 308 to update the database the location (loc 2) of the security bag 300;
whereby the security bag 300 is able to be tracked by a user from a point of deposit (Loc. 1) until reaching a destination (Loc. 2) by remote accessing of the database 464 using the user device 410.

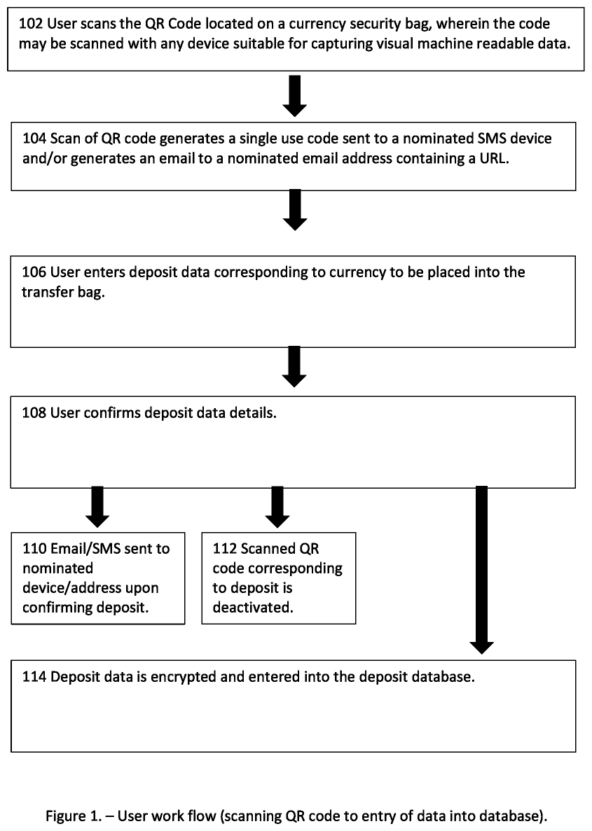

FIG. 1 illustrates an embodiment of a user work flow of the method. In this embodiment a user is provided with a security bag 300 and scans the QR code 306 at 102. Scanning 104 the QR code 306 provides a single use code sent to a nominated device (such as user device 410) by a message service or email with a URL to enter 106 deposit data, such as the currency 310 that is placed in the security bag 300. The amount of currency may be the total amount to it may break down the denominations of the notes inserted. The URL takes the user to a website on the user device 410 which is generated by the server 432 and in which the deposit information can be entered for storage in the database 464. The user may enter the number and denominations of notes (or other currency) inserted in the security bag 300. For example, 100 $50 notes are entered and the server then knows that $5,000 is in the security bag. Once this is entered into the website, the website will ask the user to verify that this is correct. The user confirms the correctness at 108, or changes the entry. At 110 an email or text message is sent to the user's device 410 confirming the deposit. The scanned QR code 306 is deactivated 112 (at least until next time the security bag is reissued for use again). The data entered is encrypted and stored in the deposit database 434.

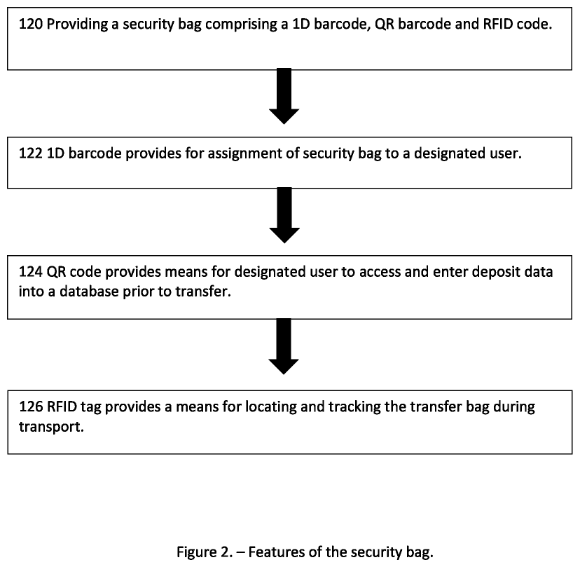

FIG. 2 shows an embodiment of the features of the deposit bag 300 including providing 120 the 1D barcode 304, the QR code 306 and the RFID 308, At 122, the 1D barcode 304 provides for assigning a transfer bag to a user. This may be performed by a bank or third-party security bag issuer. At 124, the QR code 306 is for providing a means to receive a URL link to enter deposit data. At 126, the RFID tag 308 is for providing means for locating and tracking the security bag during or upon completion of transport.

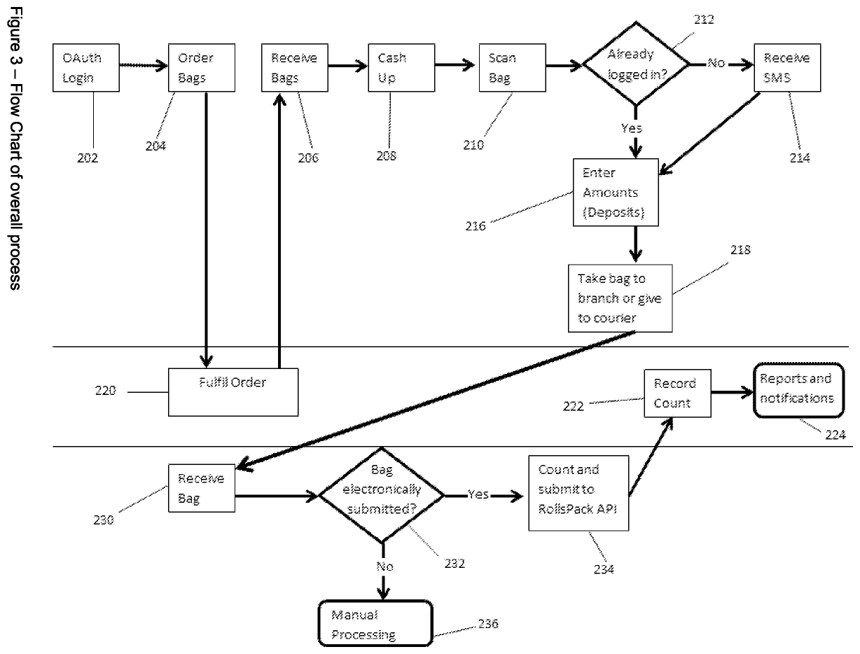

FIG. 3 shows a flow process 200 according to an embodiment of the present invention, which commences with an authorised user making a login to a website, for example generated by the server 430. The user orders one or more bags 204. A supplier of the bags, such as a bank, fulfils 220 the order by providing the bags to the user. In doing so the bank may record the identifications of the bags sent to that user by scanning of one of the identifiers (eg. 1D barcode, QR Code or RFID), such as by using scanner 404 or 406, and allocating the identifiers to the identity of the user in the database 434. The ordered bags are received by the user at 206. One of the bags 300 is use by placing the currency in the bag 208 so that it is “cashed up”. The user scans 210 one of the identifiers (e.g. 1D barcode, QR Code or RFID) with scanner 402. The scanner 402 may be for example a camera of a smart phone (user device 410) where the code scanned is the QR code 306. The device 410 checks whether the user is already logged into the website at 212. If not logged in a message is sent to the device 410 with a website URL and unique session identifier at 214. Activation of the URL takes the user to a website generated by the server 430. At 216 the user enters 216 the amount of currency put in the bag 300 into the website.

The amount is stored in the database 434 against the identity of the bag 300. The bag 300 is then taken for transport, such as being taken from the start location (Loc. 1) to a bank branch or by a security transport firm at 218 to a deposit facility.

The bag 300 is received 230 at the destination (Loc 2). If the bag is received and has not entered into the database 434 it is manually processed at 236. If it was entered, receipt of the bag 300 is recoded by scanning gone of the identifiers (e.g. 1D barcode, QR Code or RFID), such as by using scanner 404. The receipt of the bag may be stored in the database 434. The bag 300 may be moved from a receipt location (Loc 2) to a counting location (Loc 3). The movement from Loc 2 to Loc 3 may be recorded by use of scanner 406.

The content of the bag is checked 234 (such as by counting the currency). The counted amount can be verified against the amount of currency recorded in the database 434 via the bank device 420 and API access to the server 430 at 222. The user can check the transfer by accessing the website via their device 410. A report of the receipt of the currency is generated at 224. This notification may be sent to the user, such as by email or SMS.

Finally, it is to be understood that various alterations, modifications and/or additions may be made without departing from the spirit of the present invention as outlined herein.

1. A method for tracking currency transfer, comprising the steps of:
providing a security bag for holding currency;
depositing currency into the security bag;
entering information corresponding to the security bag into a database; and
updating the database with at least one location of the security bag;
wherein the security bag may be tracked by a user from a point of deposit until reaching a destination by remote accessing of the database.

2. The method according to claim 1, wherein the security bag comprises:
a machine readable code; and
a wireless identifier;
which enable said currency security bag to be identified so that the security bag can be tracked from a point of deposit until reaching a destination.

3. The method according to claim 2, wherein the machine readable code comprises a primary barcode in the form of a 1D barcode, wherein the primary barcode provides access to the database and allows for allocation to a unique ID tag to the security bag in the database.

4. The method according to claim 2, wherein the machine readable code comprises a secondary barcode comprising information that provides access to the database.

5. (canceled)

6. The method according to claim 4, wherein the secondary barcode provides access to a deposit URL, for recording deposit data regarding the contents of the security bag, wherein said deposit data includes auto-populated data corresponding to the unique ID tag.

7. (canceled)

8. The method according to claim 4, wherein the secondary barcode is a QR code.

9. (canceled)

10. The method according to claim 6, wherein the user confirms the data recorded regarding the contents of the security bag, and upon confirmation of the deposit data recorded into the deposit URL:
the secondary code corresponding to the security bag is deactivated;
the user is sent a confirmation notification; and/or the deposit data is encrypted and entered into the deposit database,
wherein the encrypted deposit data is able to be accessed by the depositor or by the recipient when the security bag arrives at the destination.

11. (canceled)

12. (canceled)

13. (canceled)

14. (canceled)

15. The method according to claim 2, wherein the wireless identifier comprises an RFID tag and provides access to the database to allow for viewing:
data corresponding to the unique ID tag, and/or
data corresponding to the deposit data;
and wherein the RFID tag further provides additional information to the database, providing a means for entry of status data.

16. (canceled)

17. (canceled)

18. The method according to claim 1, wherein the step of depositing currency into the security bag comprises:
placing currency to be transferred inside the bag, and/or
scanning a secondary code to receive a unique deposit code corresponding to the bag.

19. The method according to claim 1, wherein the information corresponding to the security bag comprises:
personal details of the user, and/or
details of currency to be deposited.

20. The method according to claim 1, wherein the step of providing the security bag comprises:
a user accessing a stock management interface, and
entering data including number of bags into the stock management interface;
recording the identity of each bag sent to the user.

21. The method according to claim 1, wherein upon depositing the bag a user receives a confirmation notification including the details of the deposit.

22. The method according to claim 1, wherein said database provides notification when a security bag has already been used; and/or
wherein said database provides means for generating a report, wherein said report is in the form of a CSV file or similar format.

23. (canceled)

24. (canceled)

25. A currency security bag comprising:
a primary barcode,
a secondary barcode, and
an RFID tag;
which enable said currency security bag to be tracked from a point of deposit until reaching a destination.

26. A tracking system for tracking currency transfer in a security bag having a machine readable code and a wireless identifier, said system comprising:
a first reader, a server and a second reader;
wherein the first reader is operatively arranged to read the machine readable code at a commencement location, the reader operatively arranged to read the machine readable code and extract information and an identifier of the security bag from the code, the information operative to trigger a connection to a remote server;
wherein the remote server is arranged to receive the identifier and information about the currency to be transported and recording the identifier and the currency information;
wherein the second reader is operatively arranged to receive an identifier of the security bag from the wireless identifier at a destination location;
wherein the remote server is configured upon receipt of the identifier by the second reader to receive from a destination device said identifier, wherein the server is configured to retrieve the information about the currency based on the identifier provided to the server and one or both of: provide the information about the currency to the destination device; and record the time of the second reader receiving the identifier of the security bag.

27. A computer program embodied in a physical form comprising instructions for controlling a computer to:
receive from a first reader at a first remote location an identifier of a security bag read from a code on the security bag by the first reader;
provide to a user of the first reader a link that enables a connection to the server;
receive from the user information about currency to be transported in the security bag; record the identifier and the currency information;
receive from a second reader at a second location an identifier of the security bag read from a wireless identifier on the security bag by the second reader;
retrieving the currency information based on the identifier of the security bag read from a wireless identifier;
sending to a destination device at the second location the retrieved currency information.

28. The computer program according to claim 27, wherein the instructions are also configured to control the computer to:
record the time of the second reader receiving the identifier of the security bag; and
provide the recorded time to the user.

29. A system comprising means for implementing the computer program according to claim 27.

30. A method performed by a system when executing the computer program according to claim 27.
